(19) United States
(12) Patent Application Publication
(10) Pub. No.: US 2002/0012581 A1
(43) Pub. Date: Jan. 31, 2002

(54) Substrate processing apparatus and method for manufacturing a semiconductor device

(75) Inventors: Shigeru Odake, Tokyo (JP); Kazuhiro Morimitsu, Tokyo (JP); Hidehiro Yanagawa, Tokyo (JP)

Correspondence Address: BACON & THOMAS, PLLC, 625 Slaters Lane, 4th Floor, Alexandria, VA, 22314-1176, US

(73) Assignee: Hitachi Kokusai Electric Inc., Tokyo (JP)

(21) Appl. No.: 09/912,323

(22) Filed: Jul. 26, 2001

(30) Foreign Application Priority Data
Jul. 27, 2000 (JP) 2000-226800

(51) Int. Cl. B66C 17/08; B65G 67/16

(52) U.S. Cl. 414/804

(57) ABSTRACT

In a CVD apparatus in which a first boat and a second boat are used, the boat detection unit and the boat identifying detection unit of the boat detection device of boat identification means are installed on a waiting plate on which a transfer process is performed by the substrate transfer device with one boat mounted thereon. Two detected bodies corresponding to the boat detection unit and the boat identifying detection unit are projected on the first boat 21A and only one detected body corresponding to the boat detection unit is projected on the second boat. If two detected bodies are detected, the boat detection device determines the boat to be the first boat and, if only one detected body is detected, the boat detection device determines the boat to be the second boat. Since either the first boat or the second boat may be identified, the substrate transfer device may be controlled by the control condition corresponding to an individual difference and, therefore, an error of the wafer transfer process may be prevented.

### FIELD OF THE INVENTION

The present invention relates to a substrate processing apparatus and method for manufacturing a semiconductor device; and, more particularly, to a substrate processing apparatus and method effectively capable of performing a heat treatment process, e.g., an annealing process, an oxygen film formation process, a diffusion process, and/or a film formation process, on a semiconductor wafer or a substrate into which a semiconductor integrated circuit having a semiconductor unit is inserted.

### BACKGROUND OF THE INVENTION

A batch of vertically arranged hot-wall type heat treatment apparatus has generally been used for performing the heat treatment such as annealing process, oxide film formation process, diffusion process and/or film formation process, on a wafer in accordance with a known method for manufacturing a semiconductor device.

Japanese Patent No. 2681055 discloses a conventional heat treatment apparatus operated as described above. In the heat treatment apparatus, a boat replacement apparatus is located between a substrate transfer device and the space under the process tube and a set of, i.e., two, boats are mounted on the rotation table of the boat replacement apparatus. If a set of boats is rotated by 180 degrees based on the rotation table, an unprocessed boat may be replaced with a completely processed boat. In other words, while one boat (a first boat) holding a plurality of wafers is processed in the processing room of the process tube, the other boat (a second boat) with a new wafer mounted thereon is conveyed by the substrate transfer device.

Since, however, in the heat treatment apparatus in which at least two boats are used, there may be inevitable differences between the two boats after an etching process and a cleaning process, the procedure for conveying the wafers to the boats by using the substrate transfer device results in an error at the conveying procedure.

### SUMMARY OF THE INVENTION

It is, therefore, an object of the present invention to provide a substrate processing apparatus and method for manufacturing a semiconductor device capable of preventing errors in the conveying procedure due to differences between two boats.

It is another object of the present invention to provide a substrate processing apparatus and method for manufacturing a semiconductor device capable of identifying the location of each boat.

In accordance with a preferred embodiment of the present invention, there is provided a substrate processing apparatus comprising:

a process tube for providing a process room therein;

at least two boats for taking a plurality of substrates in and out of the process tube;

a substrate transfer device for transferring the plurality of substrates to and from each of said at least two boats outside of the process tube; and

a boat identification device for identifying each boat at a transferring location thereof to generate an identification signal, wherein the identification signal represents a type of said each boat and the plurality of substrates are transferred to the transferring location of said each boat by the substrate transfer device.

### BRIEF DESCRIPTION OF THE DRAWINGS

The above and other objects and features of the present invention will become apparent from the following description of preferred embodiments given in conjunction with the accompanying drawings, in which:

FIG. 1 represents a horizontal cross-sectional view for illustrating a chemical vapor deposition (CVD) apparatus in accordance with an embodiment of the present invention;

FIG. 2 shows a perspective view of the CVD apparatus shown in FIG. 1;

FIG. 3 describes a perspective view for illustrating a completely processed boat under cooling process;

FIG. 4 provides a horizontal cross-sectional view of the CVD shown in FIG. 3;

FIG. 5 presents a vertical cross-sectional view for illustrating the heat treatment stage under processing;

FIG. 6 explains a vertical cross-sectional view for illustrating the heat treatment stage after boats are taken out;

FIG. 7 sets forth a perspective view for illustrating a boat conveying apparatus;

FIG. 8 describes a perspective view for illustrating a clean unit;

FIGS. 9A and 9B provide a side view for illustrating a substrate transfer device with itself curtailed and extended, respectively;

FIG. 10 represents a block diagram for illustrating a control system;

FIGS. 11A to 11E present boat identification means, wherein FIG. 11A is a plan view of a waiting stage; FIG. 11B is a front cross-sectional view which is cut off along the b-b line; FIG. 11C is a cross-sectional view which is cut off along the c-c line; FIG. 11D is a bottom view of the base of a boat; and FIG. 11E a cross-sectional view which is cut off along the e-e line;

FIGS. 12A and 12B are diagrams for illustrating the operations of the boat identification means, wherein FIG. 12A is a cutaway front view; FIG. 12B is a horizontal view which is cut off along the b-b line; FIG. 12C is a cross-sectional view which is cut off along the c-c line; and FIG. 12D is a cross-sectional view which is cut off along the d-d line.

### DETAILED DESCRIPTION OF THE PREFERRED EMBODIMENTS

In a preferred embodiment in accordance with the present invention, a substrate processing apparatus comprises a batch of vertically arranged hot-wall type diffusion CVD apparatus (hereinafter called as a CVD apparatus). In another preferred embodiment in accordance with the present invention, a substrate processing method for manufacturing a semiconductor device comprises a diffusion and CVD method (hereinafter called as a CVD method) used to perform on a wafer a diffusion and CVD process such as an annealing process, an oxide film formation process, a diffusion process and a film formation process.

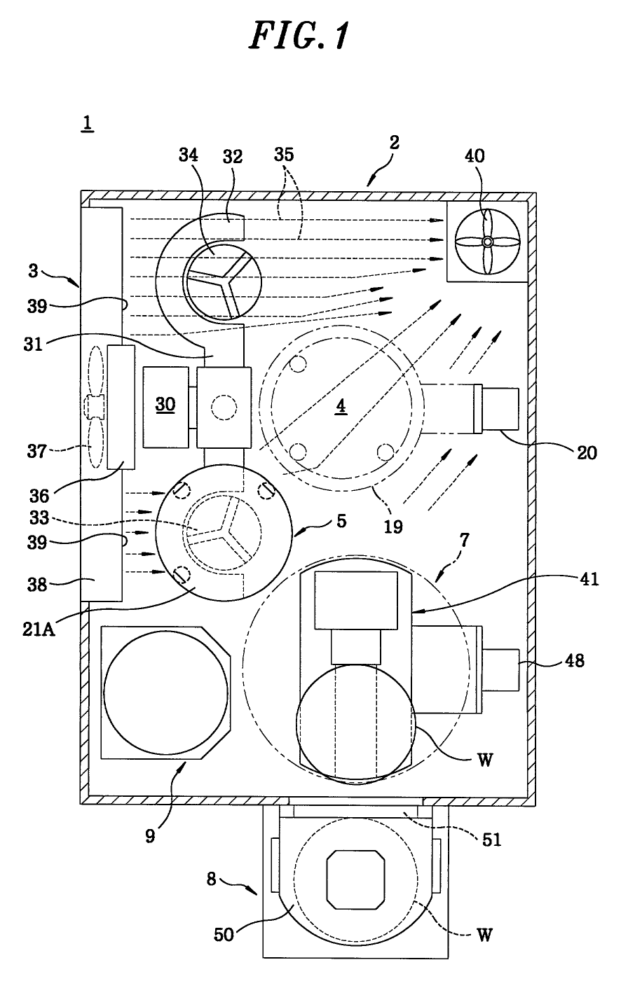

As shown in FIG. 1, the CVD apparatus 1 by which the CVD method may be performed in accordance with the present invention includes a housing body 2 having a box shape of rectangular parallelepiped with rectangle planes thereon. There is installed a clean unit 3 at the rear of the left sidewall (the left/right and the front/rear is determined based on FIG. 1), wherein the clean unit 3 is used to provide a clean air into the housing body 2. There is installed a heat treatment stage 4 around the central region of the rear within the housing body 2 and there are installed a waiting stage 5 for loading a vacant boat temporarily while waiting the heat treatment and a cooling stage 6 for loading a completely processed boat to be cooled temporally at the front/rear of the heat treatment stage 4. There is installed a wafer loading stage 7 around the central region of the front within the housing body 2 and there in installed a pod stage 8 at the front of the wafer loading state 7. There is installed a notch alignment device 9 at the left of the wafer loading stage 7. The construction of each stage will be illustrated.

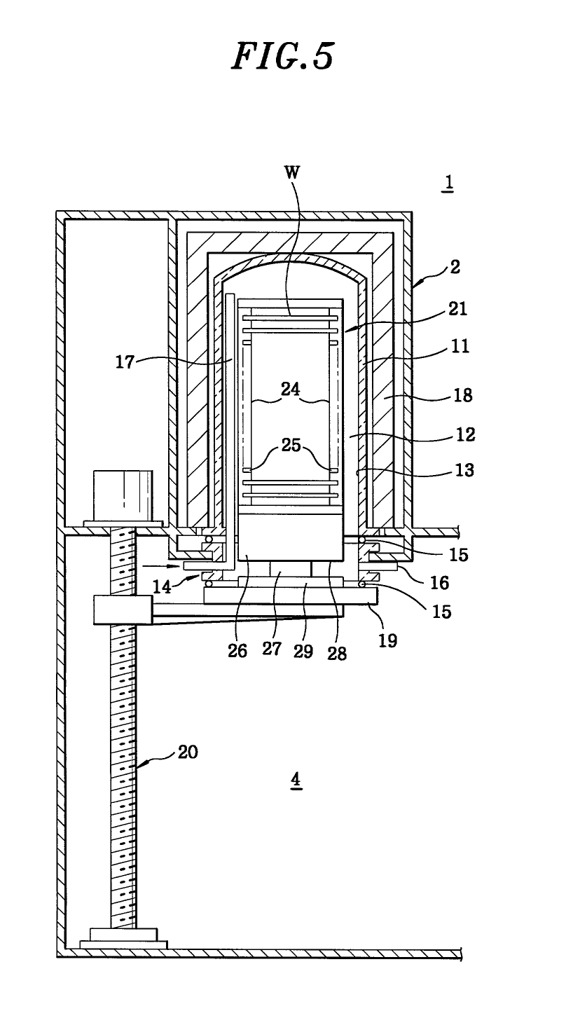

As shown in FIGS. 5 and 6, there is incorporated a process tube 11 vertically with the central line thereof to be vertical, wherein the process tube 11 with the lower part thereof opened is integrally made of quartz glass. The central cavity region of the process tube 11 forms a processing room 12 in which the boat is used to bring a plurality of wafers, the plurality of wafers being concentrically arranged, and the opening in the lower part of the process tube 11 constitutes a furnace inlet 13 for taking the wafers as the substrates to be processed in and out of. Accordingly, the internal diameter of the process tube 11 is set to be larger than the maximum external diameter of wafers to be processed.

The lower end of the process tube 11 is maintained to be contacted with the upper surface of a manifold 14 with a seal ring 15 inserted therebetween and the manifold 14 is supported by the housing body 2 so that the process tube 11 may be maintained to be supported vertically. An exhaust pipe 16 is connected to the processing room 12 through a portion of the sidewall of the manifold 14 and the other end of the exhaust pipe 16 is connected to a vacuum exhaust device (not shown) for exhausting the processing room 12 to a predetermined vacuum degree. A gas inlet pipe 17 is connected with the processing room 12 through the other portion of the sidewall of the manifold 14 and the other portion of the gas inlet pipe 17 is connected to a gas providing device (not shown) for providing gas, e.g., source gas or nitrogen gas.

A heater unit 18 is concentrically installed surrounding the process tube 11 outside the process tube 11 and there is installed the heater unit 18 supported vertically by the housing body 2. The heater unit 18 has a structure for heating the processing room 12 uniformly.

At the heat treatment stage 4, there is installed a cap 19 under the process tube 11, wherein the cap 19 having the shape of a discus is concentrically arranged and the diameter of the cap 19 is substantially equal to the outer diameter of the process tube 11. The cap 19 is controlled to be lift upwardly or downwardly by the elevator 20 having a conveying screw device. The cap 19 is used to support the boat 21 vertically along the central line.

Two boats 21 are loaded to the cap 19 to be supported one after the other and then taken in and out of the process tube 11. Two boats have basically the same design and construction but they may have an individual difference due to for example the processing deviation, the fabrication deviation, the washing by an etching process. Since two boats 21 have basically the same design and construction, only one boat 21 will be illustrated on behalf of two boats 21 except two boats 21 are required to be distinguished.

As shown in FIGS. 5 and 6, the boat 21 has one set of end boards 22 and 23 and a plurality of holding members wafer 24 vertically installed between two end boards 22 and 23, wherein 3 holding members are shown for illustration in the present embodiment. A number of holding grooves 25 are carved on each holding member 24 with the same pitch between two neighboring holding grooves in order that three corresponding holding grooves of three holding members 24 may be carved on the same plane. A wafer W may be inserted between three corresponding holding grooves 24 so that a plurality of wafers may be aligned in parallel and with the centers of the holding grooves 24 coincided with each other.

An adiabatic cap part 26 is formed under the lower end board 23 of the boat 21; and a backbone 27 is vertically projected downwards under the adiabatic cap part 26 as a column with a diameter smaller than the outer diameter of the adiabatic cap part 26. A space in which an arm of the boat conveying apparatus is inserted as described hereinafter is formed under the lower surface of the backbone 27 under the lower surface of the adiabatic cap part 26; and a connection part 28 for connecting the arm with an outer neighboring part under the lower surface of the backbone 27 is also formed.

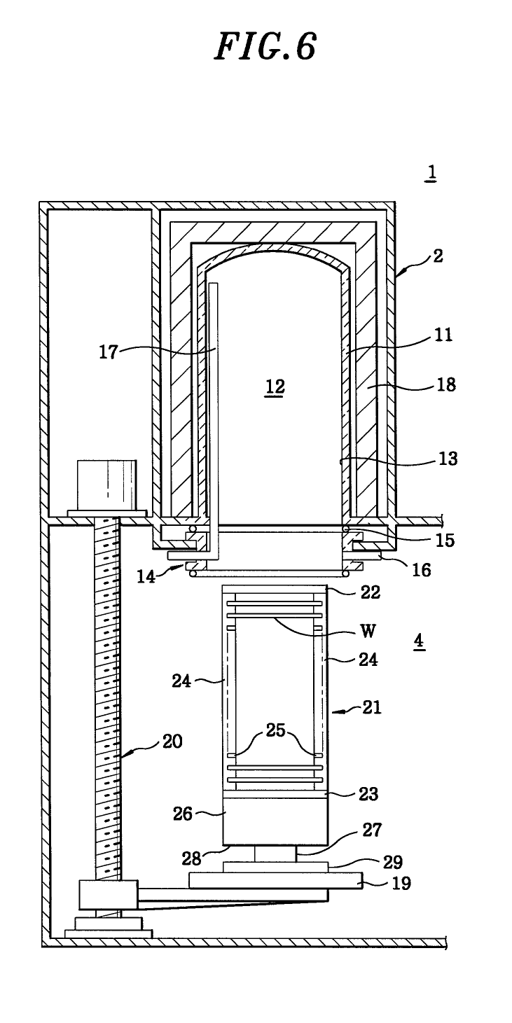

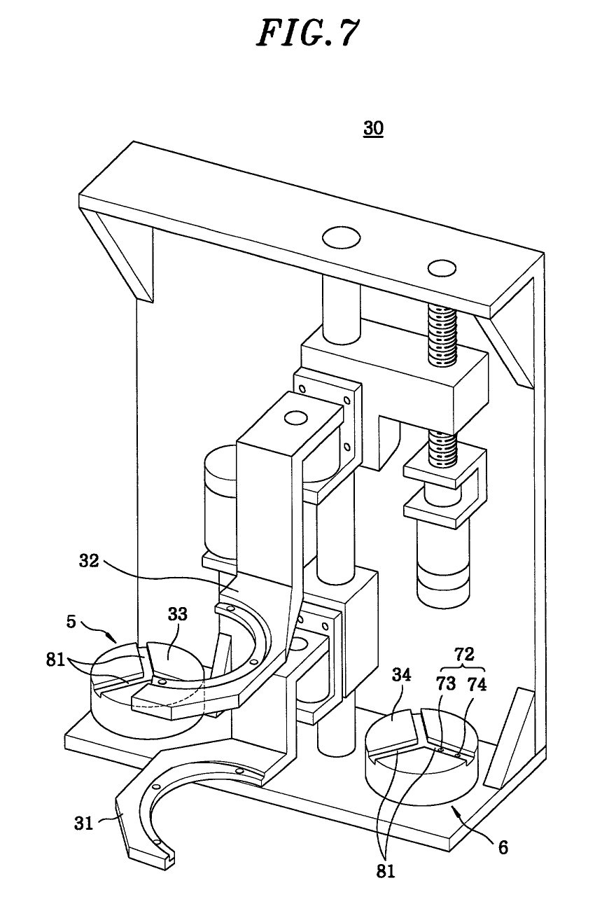

Referring to FIG. 1, a boat conveying apparatus 30 for conveying the boat 21 between the heat treatment stage 4 and the waiting stage 5 or the cooling stage 6 is installed between the waiting stage 5 and the cooling stage 6. As shown in FIG. 7, the boat conveying apparatus 30 includes a selective compliance assembly robot arm (SCARA) so that it may contain a set of first arm 31 and second arm 32 which may be reciprocally rotated by about 90 degrees on a horizontal plane. Both the first arm 31 and the second arm 32 are formed on a circle and inserted into an outside of the backbone 27 of the boat 21 to be coupled with the connection part 28 of the adiabatic cap part 26 so that they may support all the boat 21 vertically.

As shown in FIGS. 1 and 7, a waiting die 33 for supporting the boat 21 vertically is installed on the waiting stage 5 and the first arm 31 is used to allow the boat 21 to be conveyed between the waiting plate 33 and the cap 19 of the heat treatment stage 4. A cooling plate 34 is installed on the cooling stage 6 and the second arm 32 is used to allow the boat 21 to be conveyed between the cooling plate 34 and the cap 19 of the heat treatment stage 4.

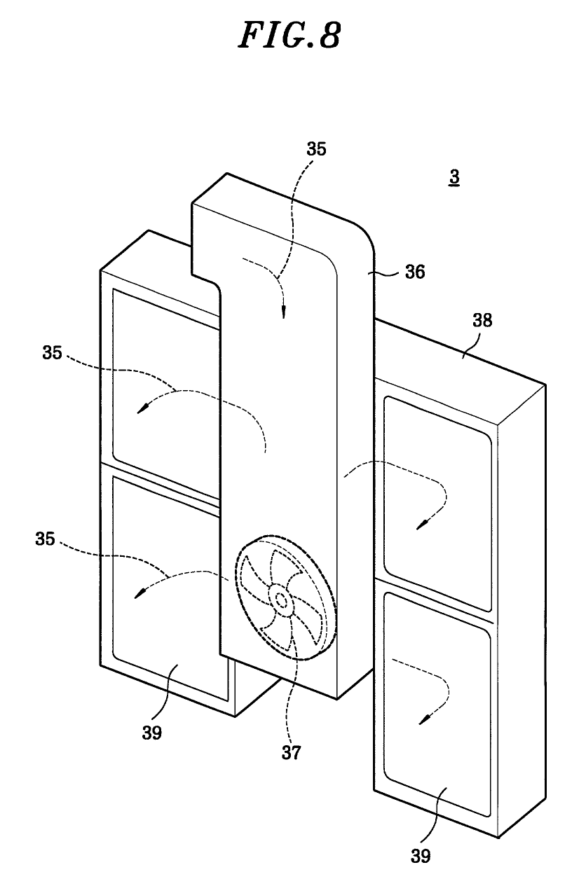

As shown in FIG. 1, the clean unit 3 for providing a clean air 35 into the housing body 2 is incorporated to inject the clean air 35 toward the waiting stage 5 and the cooling stage 6. In other words, as shown in FIG. 8, the clean unit 3 includes an inhaling duct 36 for inhaling the clean air 35; and an inhaling pan 37 is installed under the lower end of the inhaling duct 36. An exhaling duct 38 is extended long back and forth at the exhaling channel of the inhaling pan 37. Two largely opened exhaling outlets 39 for exhaling the clean air 35 toward the waiting stage 5 and the cooling stage 6, respectively, are installed along the back and forth side of the inhaling duct 36 within the inner surfaces of the housing body 2 of the exhaling duct 38.

As shown in FIG. 1, an exhaust fan 40 is installed at a rear right corner within the housing body 2, wherein the exhaust fan 40 is used to inhale the clean air 35 exhaled from the exhaling outlets 39 of the clean unit 3 and to exhale the clean air 35 toward the outside of the housing body 2.

As shown in FIGS. 1 to 4, a substrate transfer device 41 made by a SCARA-type robot is installed on the wafer loading stage 7, wherein the substrate transfer device 41 allows the wafer W to be conveyed between the pod stage 8 and the waiting stage 5 so that the substrate transfer device 41 may allow the wafers mounted thereon to be conveyed between the pod and the boat 21.

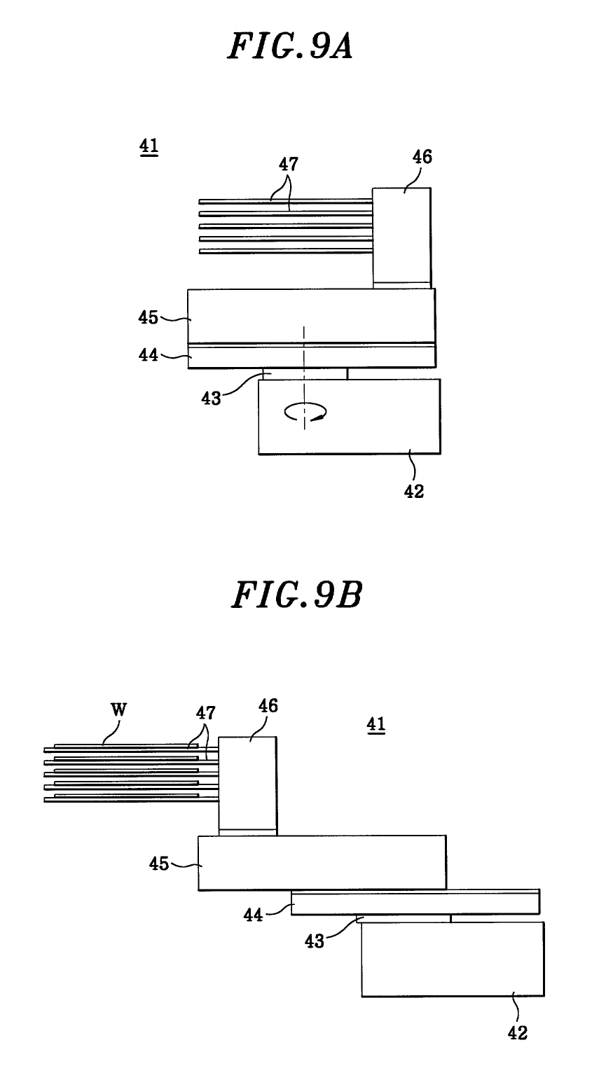

In other words, as shown in FIG. 9, the substrate transfer device 41 has a base 42 on which a rotary actuator 43 is installed. The rotary actuator 43 allows a first linear actuator 44 installed thereon to be rotated on the horizontal plane. The first linear actuator 44 allows a second linear actuator 45 installed thereon to be conveyed horizontally. The second linear actuator 45 allows a setup die 46 installed thereon to be conveyed horizontally. On the setup die 46, a number of tweezers 47 (for example, 5 tweezers in the present embodiment) for supporting wafers W from the lower surface thereof are installed horizontally and arranged at a same interval. As shown in FIGS. 1 to 4, the substrate transfer device 41 may be elevated by an elevator 48 having a conveying screw appliance.

Each pod stage 8 allows a front opening unified pod (FOUP: hereinafter called as a pod) to be mounted as a carrier (a wafer recipient case) for carrying the wafers. The pod 50 is formed with the shape of a substantially cubical box, wherein an opening is formed on a face of the substantially cubical box, and an attachable door 51 may be installed on the opening of the pod. When the pod is used as the carrier of the wafer, the wafer is carried in a sealed state. Accordingly, although there may be pollutants in the atmosphere, the cleanliness of the wafer can be maintained. Since, therefore, the cleanliness in the clean room in which the CVD apparatus is installed need not be high, the cost for the clean room can be reduced. Therefore, in the CVD apparatus in the present embodiment, the pod 50 may be used as a carrier for the wafers. Also, a door switch (not shown) may be installed in order to switch the door 51 of the pod 50 in the pod stage 8.

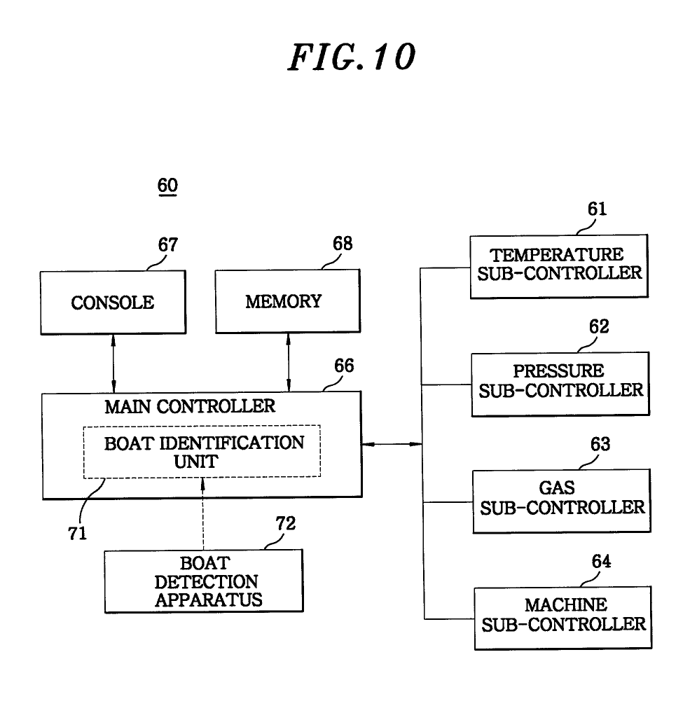

Referring to FIG. 10, there is shown a block diagram for illustrating a control system of the CVD system. A control system 60 shown in FIG. 10 includes a main controller constructed by computer and a plurality of sub-controllers. The sub-controllers include a temperature sub-controller 61 for controlling temperature of the processing room, a pressure sub-controller 62 for controlling pressure of the processing room, a gas sub-controller 63 for controlling a gas flow rate of gases such as raw gas, carrier gas and/or purge gas and a machine sub-controller 64 for controlling machines such as elevators, boat conveying apparatuses and/or wafer transfer apparatuses, wherein the sub-controllers are connected by a control network 65 to a main controller 66.

The main controller 66 is connected to a console (a control table) 67 which is used as display means and input means (a user interface); and a memory 68 for storing a plurality of recipes. The console 67 has at least one display, at least one keyboard and at least one mouse, wherein the display may be used to display the contents (item labels, control parameter values and so on) of the recipes and the keyboard and/or the mouse may be used to transfer the instructions of the operator.

As illustrated in the present embodiment of the present invention, a boat identification unit 71 of the boat identification means is constructed (programmed) within the main controller 66 and a detection apparatus (hereinafter called as a boat detection apparatus) 72 for detecting the boat is connected to the boat identification unit 71. The boat identification unit 71 is used to identify each boat based on the detection result of the boat detection apparatus 72 and the main controller 66 is used to transmit to each sub-controller instructions corresponding to each boat based on the identification result of the boat identification unit 71.

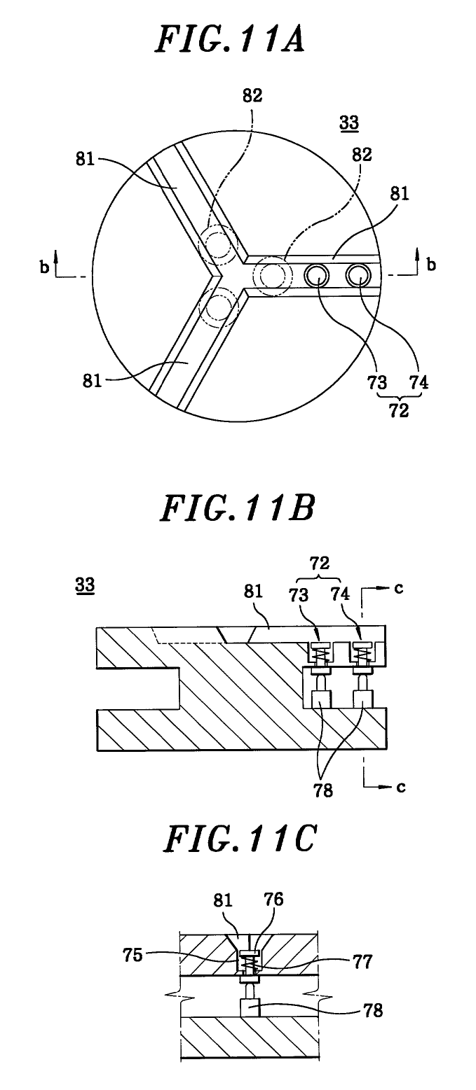

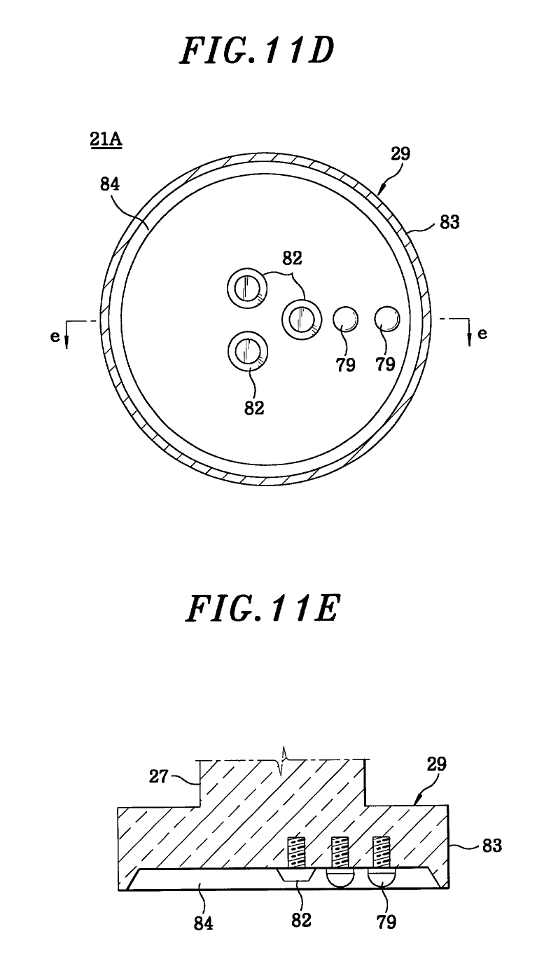

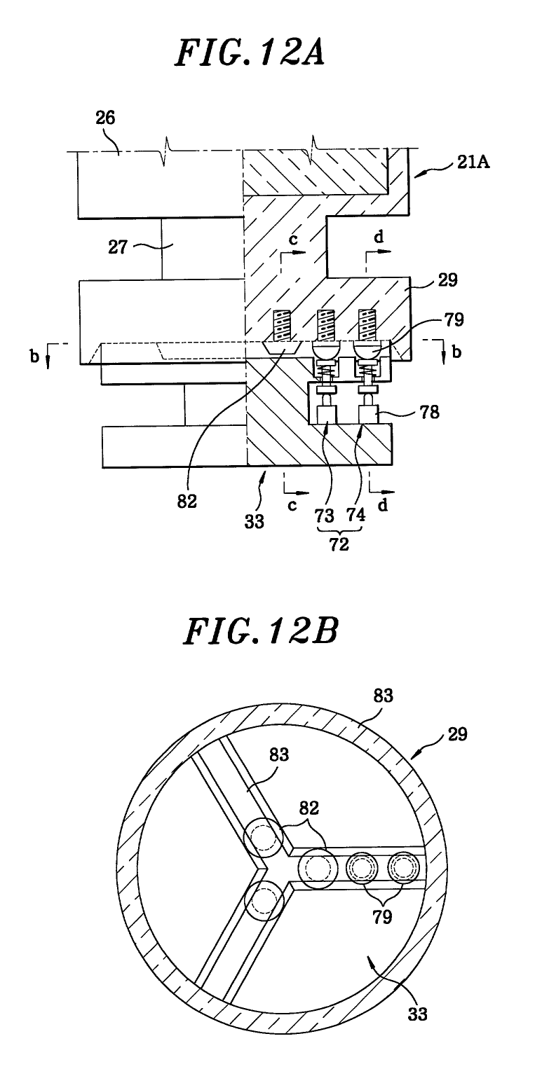

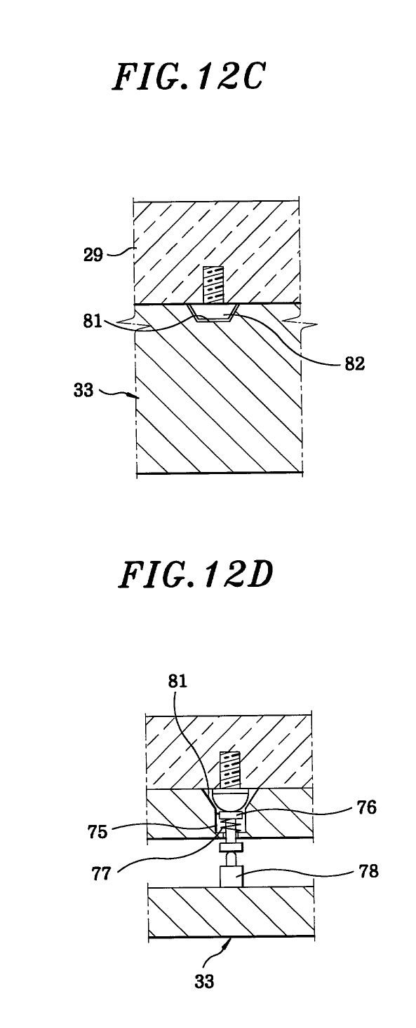

In the present embodiment, boat detection apparatuses 72 are installed on the waiting plate 33, the cooling plate 34 and the cap 19, respectively, and each of them is connected to its corresponding boat identification unit 71 of the main controller 66. In the present embodiment, since boat detection apparatuses 72 respectively installed on the waiting plate 33, the cooling plate 34 and the cap 19 have substantially same elements and constructions, the boat detection apparatus 72 installed on the waiting plate 33 shown in FIGS. 11 and 12 will be illustrated as a typical boat detection apparatus 72.

As shown in FIGS. 11 and 12, the boat detection apparatus 72 is installed on the bottom of a location alignment groove caved in the upper surface of the waiting plate 33. In other words, 3 number of location alignment grooves 81 caved in are located along the radial direction (forming the substantially Y shape) on the upper surface of the waiting plate 33 based on the center of the upper surface of the waiting plate 33, wherein each location alignment groove 81 forms an inverse trapezoidal cross-sectional elongated groove and the boat detection apparatus 72 is located along the neighboring portion of the lower surface of one of the 3 location alignment grooves 81. The 3 location alignment grooves 81 may be connected to 3 location alignment bosses 82 projected under the lower surface of the base 29 of the boat 21, respectively. In other words, each of the 3 location alignment bosses 82 has shaped with a circular truncated cone which has a trapezoidal cross-section corresponding to an inverse trapezoidal cross-section of the location alignment groove 81 and has been located at a same angle interval, e.g., 120 degrees, along the circular direction in order to be inserted to the 3 the location alignment grooves 81 on a concentric circle based on the center of the lower surface of the base 29. A location alignment ring unit 83 is projected downwards along the outer circle region of the lower surface of the base 29, wherein the location alignment ring unit 83 has an arm taper-shaped unit 84 along the inner surface of the location alignment ring unit 83. The arm taper-shaped unit 84 of the location alignment ring unit 83 is to be inserted to the outer circle surface of the waiting plate 33.

As shown in FIGS. 11 and 12, the boat detection apparatus 72 includes a boat detection unit 73 for detecting whether there exists a boat 21 on the waiting plate 33 and a boat identifying detection unit 74 for identifying the boat 21 mounted on the waiting plate 33, wherein the boat detection unit 73 and the boat identifying detection unit 74 have substantially same elements and constructions. In other words, both the boat detection unit 73 and the boat identifying detection unit 74 include a holding hole 75 formed on the bottom of the location alignment groove 81, a plug 76 formed to be able to slide up and down along the holding hole 75, a spring 77 for always pressing the plug 76 upwards and a limit switch 78 for detecting the up and down movement of the plug 76, wherein the plug 76 detects a detected body 79 projected on the lower surface of the base 29 of the boat 21 so that the limit switch 78 may be switched. In addition, the plug 76 is formed of a material, e.g., fluorine resin, with heat resistance and abrasion resistance.

As shown in FIGS. 11E and 12D, the detected body 79 projected on the lower surface of the base 29 has a screw structure and may be adhered with an attachable structure to the lower surface of the base 29 formed by quartz or SiC. In the present embodiment, the detected body 79 corresponding to the boat identifying detection unit 74 is mounted on one boat (hereinafter called as a first boat) 21A, but is not mounted on the other boat (hereinafter called as a second boat) 21B. Therefore, if the boat identifying detection unit 74 detects the detected body 79, the boat may be determined as the first boat 21A and, if otherwise, the boat may be determined as the second boat 21B.

Hereinafter, a CVD technique within the substrate processing method by using the CVD apparatus described above in accordance with the present invention will be described based on a handling method of a pair of boats.

The CVD method is performed by a control sequence for executing a recipe of a film forming processes determined beforehand, wherein the recipe is installed on the RAM of the main controller 66 from the memory 68 and is instructed to the sub-controllers 62 to 64 to be implemented.

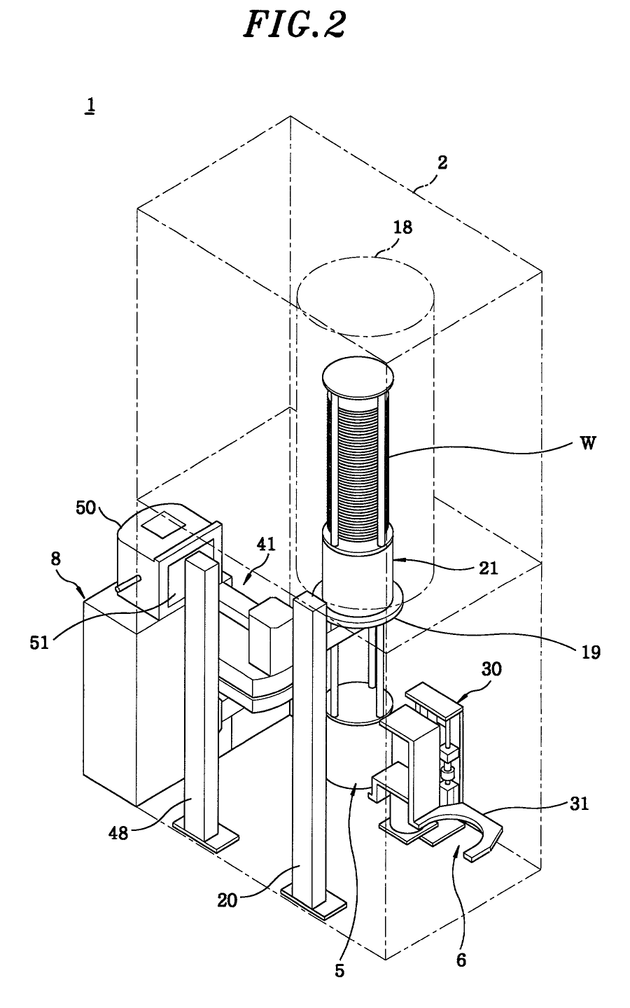

First of all, the first boat 21A is conveyed by the boat conveying apparatus 30 and mounted on the waiting plate 33 of the waiting stage 5. The wafers W stacked into the pod 50 are conveyed by the substrate transfer device 41 and, then, mounted on the first boat 21A. In other words, as shown in FIGS. 1 and 2, the first boat 21A is conveyed by the boat conveying apparatus 30 and mounted on the waiting plate 33 of the waiting stage 5. Meanwhile, as shown in FIG. 1, the pod 50 which has a plurality of wafers is provided to the pod stage 8 and, as shown in FIG. 2, door switching means allows a door 51 of the pod 50 provided to the pod stage 8 to be open.

Referring to FIGS. 9A and 9B, the second linear actuator 45 and the setup plate 46 are moved in the direction of the pod 50 so that the tweezers 47 may be inserted into the pod 50 and allowed to receive the wafers in the pod 50. Then, the tweezers 47 return to the location shown in FIG. 9A. Then, the rotary actuator 43 is reversed so that the second linear actuator 45 and the setup plate 46 may move to the waiting stage 5 and the wafers W held by the tweezers 47 are replaced with those held by the holding grooves 25 of the first boat 21A. After the substrate transfer device 41 conveys the wafers W to the first boat 21A and mounts the wafers W on the first boat 21A, it returns back and, then, reverses the second linear actuator 45 and the setup plate 46 so that the tweezers 47 may be disposed toward the pod 50 as shown in FIGS. 9A and 9B.

Since, as shown in FIG. 12A, both the boat detection unit 73 and the boat identifying detection unit 74 in the waiting plate 33 detect two detected bodies 79 of the base 29, the boat identification unit 71 of the control system 60 determines the boat is the first boat 21A and transmits the determining result to the main controller 66. In other words, if two detection signals are transmitted from both the boat detection unit 73 and the boat identifying detection unit 74, the boat identification unit 71 determines that the first boat 21A presents on the waiting plate 33. The main controller 66 informs the machine sub-controller 64 of the control condition corresponding to the first boat 21A so that it may allow the substrate transfer device 41 to control the wafer transfer process. The control condition corresponding to the first boat 21A includes a pitch of the holding groove 25 for holding the wafer and a center for defining 3 holding grooves 25 stretched into 3 directions.

If the first boat 21A is mounted on the waiting plate 33, since each of 3 location alignment bosses 82 projected on the base 29 of the first boat 21A is inserted into its corresponding location alignment groove 81 which is caved in radially on the waiting plate 33, the first boat 21A is axially aligned with the waiting plate 33 and directs in the predetermined direction. In other words, the wafer insertion direction defined by 3 holding members 24 of the first boat 21A is exactly consistent with the forwarding direction of tweezers 47 of the substrate transfer device 41. Accordingly, the transfer process may be preferably performed by the substrate transfer device 41.

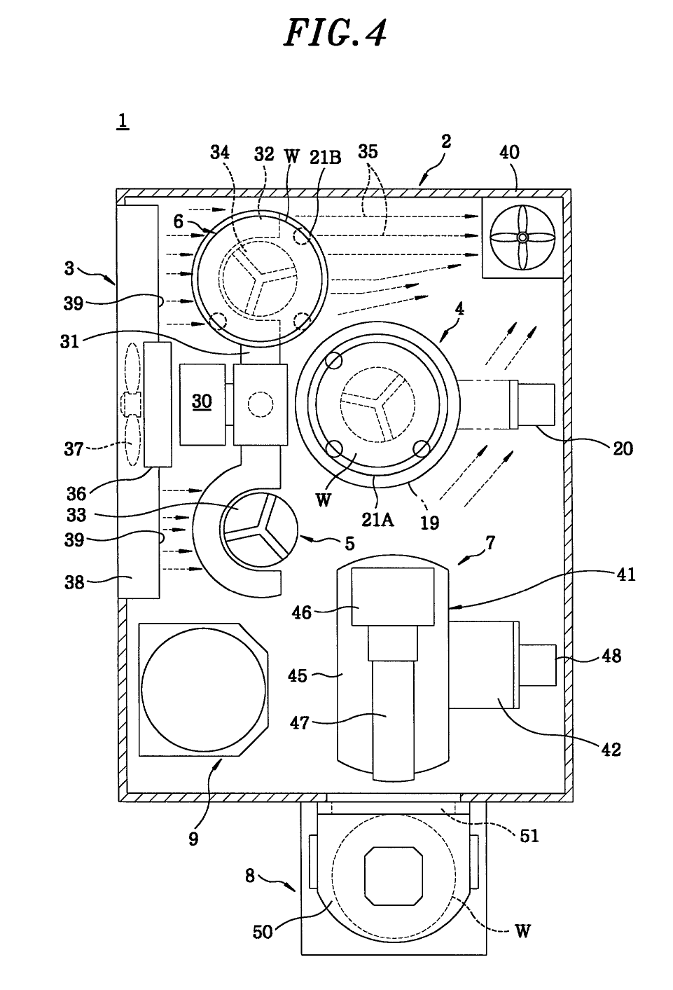

If N number of wafers are loaded on the first boat 21A, N being a positive integer determined by the waiting stage 5, the first boat 21A is conveyed from the waiting stage 5 to the heat treatment stage 4 by the first arm 31 of the boat conveying apparatus 30 as shown in FIG. 4 so that it may be conveyed to and mounted on the cap 19. In other words, the first arm 31 is inserted along the outside of the backbone 27 of the first boat 21A and connected with the connection part 28 of the adiabatic cap part 26 through the lower part of the first arm 31. Then, the first arm 31 may be rotated by about 90 degrees with the first boat 21A supported vertically so that the first boat 21A may be conveyed from the waiting stage 5 to the heat treatment stage 4 and may be given to or taken from the cap 19. After the first arm 31 allows the first boat 21A to be conveyed to and mounted on the cap 19, the first arm 31 returns to the waiting stage 5.

Since the boat detection apparatus 72 and the location alignment groove 81 are also arranged on the cap 19 as arranged on the waiting plate 33, the first boat 21A conveyed to and mounted on the cap 19 will be exactly aligned and the boat identification unit 71 determines the presence of the first boat 21A and, if any, identifies the type of the first boat 21A. The main controller 66 informs the temperature sub-controller 61, the pressure sub-controller 62 and the gas sub-controller 63 of the control conditions corresponding to the first boat 21A. The control condition corresponding to the first boat 21A may include a gas providing control corresponding to a pitch of the holding groove 25 for holding the wafer and a center for defining 3 holding grooves 25 stretched into 3 directions.

As shown in FIG. 5, the elevator 20 is used to lift the first boat 21A vertically supported by the cap 19 so that the first boat 21A is inputted into the processing room 12 of the process tube 11. If the first boat 21A arrives at the top, since the outer neighboring portion of the upper surface of the cap 19 and the lower surface of the manifold 14 are maintained with the seal ring 15 inserted therebetween so that the lower end opening of the manifold 14 is closed in a sealing state, so that the processing room 12 turns to be in a state of sealing state.

If the cap 19 is used to close the processing room 12 in the sealing state, the exhaust pipe 16 is used to produce a vacuum in the processing room 12 to a predetermined degree of vacuum and a heating unit 18 is used to heat the processing room 12 totally and uniformly to a predetermined processing temperature (e.g., 800 to 1000 degrees). If the temperature in the processing room 12 is stabilized, the processing gas is introduced to the processing room 12 through the gas inlet pipe 17 with a predetermined flow rate. Therefore, a predetermined film formation process may be performed.

While the film formation process is performed on the first boat 21A, the boat conveying apparatus 30 is used to convey the second boat 21B to the waiting plate 33, mounted thereon, of the waiting stage 5 and the substrate transfer device 41 is used to charge the wafers W on the pod 50 to the second boat 21B. Since each of 3 location alignment bosses 82 projected on the base 29 of the second boat 21B is inserted into its corresponding location alignment groove 81 which is caved in radially on the waiting plate 33, the second boat 21B is axially aligned with the waiting plate 33 and directs in the predetermined direction. In other words, the transfer process on the second boat 21B of the wafer W may be preferably performed by the substrate transfer device 41.

Since the detected body 79 corresponding to the boat identifying detection unit 74 is not mounted on the base 29 of the second boat 21B, the boat detection unit 73 in the boat detection apparatus 72 detects the detected body 79 while the boat identifying detection unit 74 has not detected the detected body 79. So the boat identification unit 71 of the control system 60 determines the boat to be the second boat 21B and transmits the determining result to the main controller 66. In other words, if the detection signal is transmitted from only the boat detection unit 73, the boat identification unit 71 determines the second boat 21B presents on the waiting plate 33. The main controller 66 informs the machine sub-controller 64 of the control condition corresponding to the second boat 21B so that the main controller 66 allows the substrate transfer device 41 to control the wafer transfer (charging) process as described above.

In the meantime, if a predetermined processing time is elapsed for the first boat 21A inserted in the process tube 11, the cap 19 for holding the first boat 21A is dropped by the elevator 20, as shown in FIG. 6, so that the first boat 21A may be taken out of the processing room 12 of the process tube 11. While the first boat 21A is taken out of the processing room 12 of the process tube 11, the wafers held by the first boat 21A continues to be in a high temperature state.

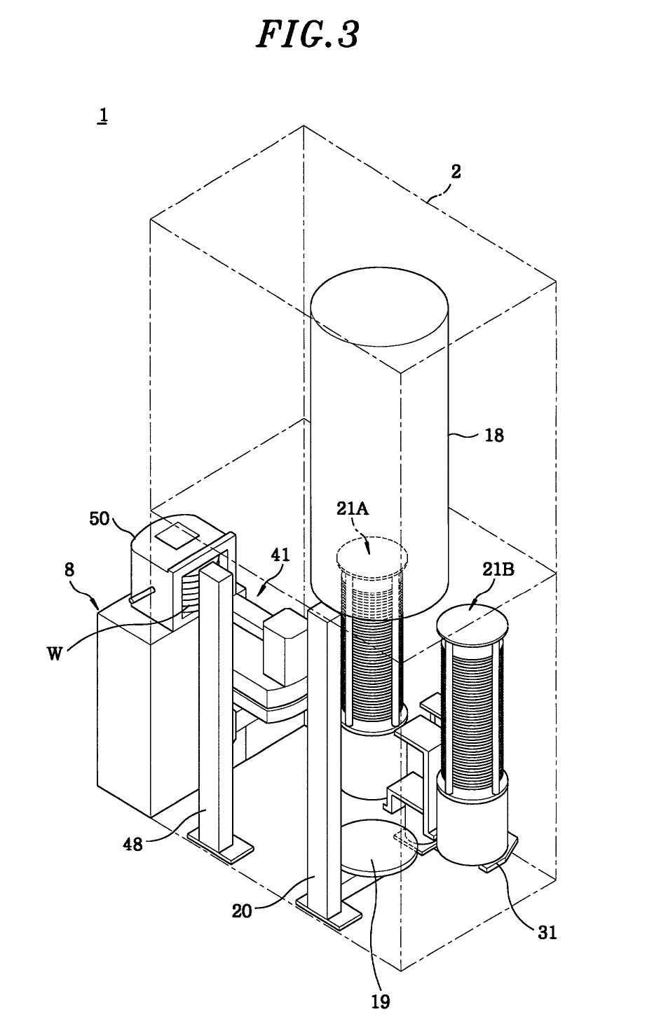

The first boat 21A completely processed in the high temperature is taken out of the processing room 12 so that it may be immediately conveyed from the heat treatment stage 4 on the same axial line of the process tube 11 to the cooling stage 6 by the second arm 32 of the boat conveying apparatus 30 as shown in FIG. 3. The second arm 32 is inserted along the outside of the backbone 27 of the second boat 21B completely processed so that it may be connected with the connection part 28 of the adiabatic cap part 26 through the lower part of the second arm 32. Then, the second arm 32 may rotate the first boat 21A completely processed by about 90 degrees while the first boat 21A being supported vertically so that the first boat 21A may be conveyed to and mounted on the cooling plate 34 of the cooling stage 6 from the cap 19 of the heat treatment stage 4.

Since the boat detection apparatus 72 and the location alignment groove 81 are likely arranged in the cooling plate 34 as arranged in the waiting plate 33, the first boat 21A conveyed to and mounted on the cooling plate 34 is exactly aligned and both the detection of the existence of the first boat 21A and the identification of the type thereof may be performed by the boat identification unit 71.

Since, as shown in FIG. 4, the cooling stage 6 is located near to the clean air exhaling outlet 39 of the clean unit 3, the high-temperature first boat 21A conveyed to and mounted on the cooling plate 34 of the cooling stage 6 may be effectively cooled by the clean air 35 exhaled from the exhaling outlet 39 of the clean unit 3.

After the first boat 21A on the cooling plate 34 is cooled down to for example lower than 150° C., the first boat 21A is conveyed by the boat conveying apparatus 30 through the heat treatment stage 4 to the waiting stage 5. In other words, the second arm 32 of the boat conveying apparatus 30 is inserted along the outside of the backbone 27 of the first boat 21A so that it may be connected with the connection part 28 of the adiabatic cap part 26 through the lower part of the first arm 31. Then, the second arm 32 may be rotated by about 90 degrees with the first boat 21A supported vertically so that the first boat 21A may be conveyed from the cooling stage 6 to the heat treatment stage 4. If the first boat 21A is conveyed to the heat treatment stage 4, the first arm 31 of the boat conveying apparatus 30 is rotated by about 90 degrees toward the heat treatment stage 4 so that it may receive the first boat 21A of the heat treatment stage 4. After the first boat 21A is received, the first arm 31 is reversely rotated by 90 degrees to the original location so that the first boat 21A may be conveyed from the heat treatment stage 4 to the waiting stage 5 and mounted on the waiting plate 33. If the first boat 21A is conveyed to and mounted on the waiting plate 33, three holding members 24 of the first boat 21A allow the substrate transfer device 41 to be open.

If the first boat 21A returns to the waiting plate 33, the substrate transfer device 41 receives the completely processed wafer W from the first boat 21A of the waiting plate 33 so that the wafers are conveyed to and mounted on the pod 50 of the pod stage 8. Since, as shown in FIG. 12A, both the boat detection unit 73 and the boat identifying detection unit 74 have detected both of the detected bodies 79 of the base 29, the boat identification unit 71 of the control system 60 determines the boat as the first boat 21A and transmits the determination result to the main controller 66. The main controller 66 informs the machine subcontroller 64 of the control condition corresponding to the first boat 21A so that it may allow the substrate transfer device 41 to control the wafer transfer process (discharging process) from the first boat 21A to the pod 50.

Since each of the 3 location alignment bosses 82 projected on the base 29 of the first boat 21A is inserted into its corresponding location alignment groove 81 which is caved in radially on the waiting plate 33, the first boat 21A is axially aligned with the waiting plate 33 and directs in the predetermined direction. Accordingly, the process for discharging the wafer from the first boat 21A to the pod 50 may be preferably performed by the substrate transfer device 41.

If all the completely processed wafers return to the pod 50, a new wafer W to be processed next is charged on, i.e., conveyed to and mounted on, the first boat 21A of the waiting plate 33 by the substrate transfer device 41.

The operation will be repeated between the first boat 21A and the second boat 21B so that a plurality of wafers may be processed by the CVD apparatus 1.

In accordance with the present invention, the effects are obtained as follows.

(1) Since the boat identification unit 71 identifies either the first boat 21A or the second boat 21B based on the detection signal from the boat detection apparatus 72 of the boat identification means so that the main controller 66 may adequately instruct the control condition of the substrate transfer device 41 which corresponds exactly to either the first boat 21A or the second boat 21B, the transfer process of the substrate transfer device 41 may be prevented from failing due to a difference between the first boat 21A and the second boat 21B.

(2) Since the boat identification unit 71 identifies either the first boat 21A or the second boat 21B based on the detection signal from the boat detection apparatus 72 of the boat identification means so that the main controller 66 may adequately generates control conditions of the temperature sub-controller 61, the pressure sub-controller 62 and gas sub-controller 63 which correspond to either the first boat 21A or the second boat 21B, the quality and credibility in the CVD method may be increased.

(3) Since the adjustment of the control conditions results in the change of the conditions for manufacturing a film on the wafer, a difference load set between the first boat 21A and the second boat 21B may be used and only one CVD apparatus 1 may be used to make a plurality of films.

(4) Three boat detection apparatuses 72 are arranged on the waiting plate 33, the cooling plate 34 and the cap 19, respectively, the current location of the first boat 21A and the second boat 21B may be detected. Since, for example, the locations of the first boat 21A and the second boat 21B are exactly detected at the beginning of the process for making the film after the lightout is recovered, the next processes on the first boat 21A and the second boat 21B may be exactly performed.

(5) If the moving history of the boat may be stored in a file based on the boat detection unit 73, the location of the boat 21 may be identified. Since, however, the identification on the location of the boat 21 is no more than a prediction, it may result in a malfunction and an accident. Since, however, the detection of the first boat 21A and the second boat 21B as described in (4) eliminates the necessity of the prediction of the locations of the first boat 21A and the second boat 21B, the malfunction and the accident can be prevented in advance in accordance with the present invention.

(6) Since the detected body 79 may be attachable and detachable to the boat 21 so that the structure difference between the first boat 21A and the second boat 21B need not be set, the manufacturing cost may be prevented from increasing.

The present invention is not confined to the present embodiment and may be modified without deviating the essence of the present invention.

For example, three boat detection apparatus of the boat identification means are not confined to be arranged on the waiting stage, the cooling stage and the heat treatment stage, respectively. It is enough that one boat detection apparatus is arranged on at least one stage, e.g., the waiting stage in the above present embodiment, on which the wafer transfer process is performed.

If the boat detection apparatus of the boat identification means is also arranged on the arm of the boat conveying apparatus, the location of the boat may be detected while the boat is conveyed.

The detected body of the boat identification means is not confined to a screw structure but the structure in which the base may be attachable to the boat may be used.

The CVD apparatus may be used to perform all the CVD processes, such as, an annealing process, an oxide film formation process, a diffusion process and a film making process.

Although the embodiment has been confined to the case for processing the wafer, a hot mask, print wiring substrate, liquid crystal panel, compact disc and magnetic disc and so on may be used.

While the invention has been shown and described with respect to the preferred embodiments, it will be understood by those skilled in the art that various changes and modifications may be made without departing from the spirit and scope of the invention as defined in the following claims.

What is claimed is:

1. A substrate processing apparatus comprising:
a process tube for providing a process room therein;
at least two boats for taking a plurality of substrates in and out of the process tube;
a substrate transfer device for transferring the plurality of substrates to and from each of said at least two boats outside of the process tube; and
a boat identification device for identifying each boat at a transferring location thereof to generate an identification signal, wherein the identification signal represents a type of said each boat and the plurality of substrates are transferred to the transferring location of said each boat by the substrate transfer device.

2. The apparatus of claim 1, wherein the substrate transfer device is controlled based on the identification signal.

3. The apparatus of claim 1, wherein a process in the process tube is controlled to be processed based on the identification signal.

4. The apparatus of claim 1, wherein there exists only one transferring location.

5. A substrate processing method for manufacturing a semiconductor device by using a substrate processing apparatus which has a process tube for providing a process room therein; at least two boats for taking a plurality of substrates in and out of the process tube; and a substrate transfer device for transferring the plurality of substrates to and from each of said at least two boats outside of the process tube, the method comprising the steps of:
identifying each boat at a transferring location thereof to generate an identification signal, wherein the identification signal represents a type of said each boat and the plurality of substrates are transferred to the transferring location of said each boat by the substrate transfer device; and
processing said each boat based on the identification signal.

6. The method of claim 5, wherein the step of processing includes the step of controlling the substrate transfer device based on the identification signal.

7. A method for manufacturing a semiconductor device of claim 1, comprising the steps of:
identifying each boat at the transferring location thereof to generate an identification signal, wherein the identification signal represents a type of said each boat and the plurality of substrates are transferred to the substrate transferring location of said each boat by the substrate transfer device; and
processing said each boat based on the identification signal.
